(19) United States
(12) Patent Application Publication
(10) Pub. No.: US 2026/0257814 A1
(43) Pub. Date: Sep. 3, 2026

(54) AERIAL VEHICLES AND RELATED METHODS

(71) Applicant: LeVanta Maritime I Inc., Springfield, MO (US)

(72) Inventors: Albert Arnau Cubillo, Bucharest (RO); Radu Cirligeanu, Buccharest (RO)

(73) Assignee: LeVanta Maritime I Inc., Springfield, MO (US)

(21) Appl. No.: 19/655,807

(22) Filed: Apr. 23, 2026

Related U.S. Application Data
(63) Continuation-in-part of application No. PCT/US2024/051824, filed on Oct. 17, 2024.
(60) Provisional application No. 63/592,561, filed on Oct. 23, 2023.

(51) Int. Cl. B64U 10/20; B64U 30/12; B64U 30/26; B64U 30/294; B64U 30/40; B64U 50/14

(52) U.S. Cl. CPC B64U 10/20; B64U 30/12; B64U 30/26; B64U 30/294; B64U 30/40; B64U 50/14

(57) ABSTRACT

Aerial vehicles and unique airfoils are disclosed herein. Methods of controlling the aerial vehicles are also disclosed herein.

### COPYRIGHT NOTICE

© 2024 LeVanta Tech Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### CROSS-REFERENCE TO RELATED APPLICATIONS

This application is a “bypass” continuation-in-part of International Patent Application No. PCT/US2024/051824, filed Oct. 17, 2024, and entitled AERIAL VEHICLES AND RELATED METHODS, which claims priority to U.S. Provisional Patent Application No. 63/592,561, filed Oct. 23, 2023 and entitled AERIAL VEHICLES AND RELATED METHODS, the contents of all of which are incorporated herein by reference in their entirety.

### FIELD OF THE INVENTION

The present disclosure relates to aerospace technology, in particular to uncrewed aerial vehicles and related methods.

### BACKGROUND

Airfoils and vehicles incorporating the same and methods of use are disclosed in WO2022040463. Additional wing-in-ground effect (WIG) vehicles are disclosed in US20230127417. A need exists for a float-and-fly uncrewed aerial vehicle (UAV).

### SUMMARY OF THE DISCLOSURE

In an aspect, a vehicle comprising an airframe operatively connected to one or more blowers; an airfoil comprising an upper surface and a lower surface extending laterally along a leading edge to first and second arcuate wingtips defining a concave region bounded by the lower surface of the airfoil, wherein the airfoil comprises a channel extending from the upper surface to the lower surface of the airfoil, wherein the channel is in fluidic communication with at least one of the one or more blowers, and a wing member operably coupling the airfoil to the airframe and providing fluidic communication between the one or more blowers and the airfoil, wherein the wing member comprises a rudder element.

In another aspect, an airfoil comprising an upper surface and a lower surface extending laterally along a leading edge to first and second arcuate wingtips defining a concave region bounded by the lower surface of the airfoil, wherein the airfoil is configured to be operatively connected to an airframe via the upper surface of each airfoil, wherein the airfoil comprises a channel extending from the upper surface to the lower surface of the airfoil, wherein the channel is configured to be in fluidic communication with at least one of one or more blowers, and wherein a lower portion of the channel is angled rearward, relative to the leading edge.

In another aspect, a method of controlling a vehicle, the method comprising: providing a flying vehicle comprising an airframe operatively connected to one or more blowers; at least two airfoils, wherein each airfoil comprises an upper surface and a lower surface extending laterally along a leading edge to first and second arcuate wingtips defining a concave region bounded by the lower surface of the airfoil, wherein the airfoil comprises a channel extending from the upper surface to the lower surface of the airfoil, wherein the channel is in fluidic communication with at least one of the one or more blowers, and first and second wing members each operably connected to separate first and second rear airfoil, wherein each wing member operably couples a respective airfoil to the airframe and providing fluidic communication between the one or more blowers and the airfoil, and wherein the first and second wing members each comprise a rudder element, respectively, and controlling roll of the vehicle, at least partially, with a pitch of the first rear airfoil relative to a pitch of the second rear airfoil, and controlling yaw of the vehicle with the rudder element on each of the first and second wing members.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a perspective view of one embodiment of an aerial vehicle disclosed herein; and

FIGS. 2A and 2B depict the results of computational fluid dynamic modeling of one embodiment of an airfoil wherein a lower portion of the internal channel is angled rearward, relative to the leading edge of the airfoil. FIG. 2A depicts a graphical front view. FIG. 2B depicts a graphical side view.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

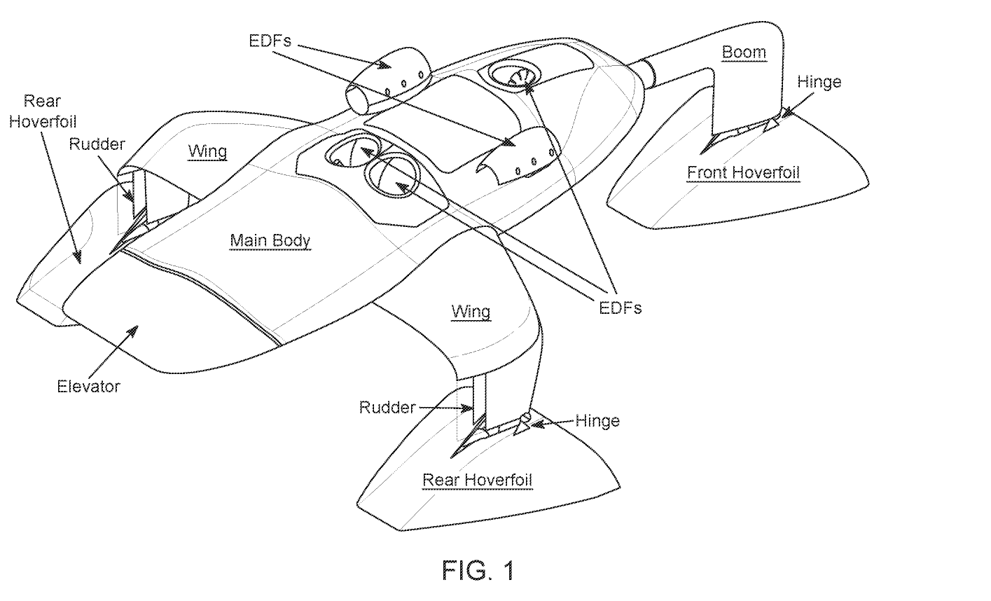

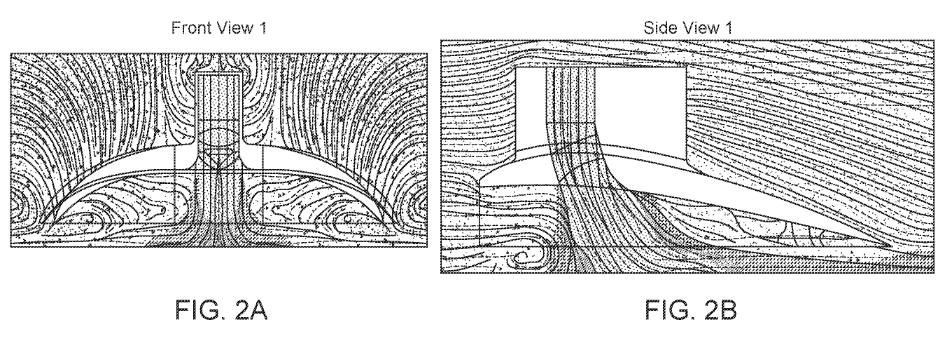

Any of the embodiments disclosed, taught and/or claimed in this application, including FIGS. 1, 2A and 2B, can include any characteristic, embodiment and/or feature disclosed, taught and/or claimed in the entireties of U.S. Non-provisional Patent Application No. 18/171,255, Attorney Docket No. 1723-001USU1, filed on February 17, 2023, and entitled “AIRFOILS AND VEHICLES INCORPORATING THE SAME,” U. S. Patent No. 12,221,210, Attorney Docket No. LVT-200-US1, filed on October 25, 2022, patented on January 22, 2025, and entitled “WING-IN-GROUND EFFECT VEHICLES AND USES THEREOF,” and U.S. Non-provisional Patent Application No. 19/638,819, Attorney Docket No. 1723-004USU1, filed on April 03, 2026, and entitled “AIRFOIL FOR AN AIRCRAFT,” each of which is incorporated herein by reference in their entirety.

Disclosed herein are vehicles comprising an airframe operatively connected to one or more blowers. The airfoil includes an upper surface and a lower surface extending laterally along a leading edge to first and second arcuate wingtips defining a concave region bounded by the lower surface of the airfoil, wherein the airfoil comprises a channel extending from the upper surface to the lower surface of the airfoil, wherein the channel is in fluidic communication with at least one of the one or more blowers. A wing member operably couples the airfoil to the airframe and provides fluidic communication between the one or more blowers and the airfoil. The wing member includes a rudder element.

The vehicle may include first and second wing members each operably connected to separate first and second rear airfoils. The separate first and second rear airfoils may be adjacent the airframe without overlapping vertically with the airframe. The airframe may include an elevator at the tail of the airframe. The airfoil may be pivotable in one dimension.

The airfoil may optionally include a nozzle extending downward from the lower surface of the airfoil in fluidic communication with the channel of the airfoil. The nozzle may be extendable and retractable.

A vehicle will typically include multiple airfoils. In certain configurations, each airfoil may be operably connected to individual blowers. The vehicle may include one or more propulsors separate from the one or more blowers.

In certain configurations, the vehicle may have a single airfoil located longitudinally in front of the airframe and operably connected to the airframe and a single blower by a boom.

Any of the vehicles disclosed herein may include an airfoil comprising an upper surface and a lower surface extending laterally along a leading edge to first and second arcuate wingtips defining a concave region bounded by the lower surface of the airfoil, wherein the airfoil is configured to be operatively connected to the airframe via the upper surface of each airfoil, wherein the airfoil comprises a channel extending from the upper surface to the lower surface of the airfoil, wherein the channel is configured to be in fluidic communication with at least one of the one or more blowers, and wherein a lower portion of the channel is angled rearward, relative to the leading edge (see, e.g. FIGS. 2A and 2B). The lower portion of the channel may be angled rearward 10 to 50 degrees, relative to vertical, 15 to 45 degrees, 20 to 30 degrees, or about 20 degrees. The angled lower portion of the channel results in thrust as well as lift when fluid is blown through the channel.

Methods of controlling a flying vehicle are also disclosed herein. The methods include providing a flying vehicle comprising an airframe operatively connected to one or more blowers, at least two airfoils, wherein each airfoil comprises an upper surface and a lower surface extending laterally along a leading edge to first and second arcuate wingtips defining a concave region bounded by the lower surface of the airfoil, wherein the airfoil comprises a channel extending from the upper surface to the lower surface of the airfoil, wherein the channel is in fluidic communication with at least one of the one or more blowers, and first and second wing members each operably connected to separate first and second rear airfoil, wherein each wing member operably couples a respective airfoil to the airframe and providing fluidic communication between the one or more blowers and the airfoil, and wherein the first and second wing members each comprise a rudder element, respectively. The methods may include controlling roll of the vehicle, at least partially, with a pitch of the first rear airfoil relative to a pitch of the second rear airfoil. The methods may further include controlling yaw of the vehicle with the rudder element on each of the first and second wing members.

When the vehicle includes a single airfoil located longitudinally in front of the airframe and operably connected to the airframe by a boom, the methods may include controlling at least partially a pitch of the vehicle by a pitch of the front airfoil.

The vehicle may include at least two propulsors separate from the one or more blowers. The methods may include controlling at least partially yaw of the vehicles by differential thrust in the at least two propulsors.

The vehicle may include an elevator at the tail of the airframe. The methods may include controlling at least partially a pitch of the vehicle by controlling a pitch of the elevator.

Modulating a pressure underneath each airfoil via control of a separate blower operably connected to that airfoil may also be used for controlling at least partially and/or stabilizing at least partially the vehicle relative to a surface, such as the ocean surface.

One embodiment of an aerial vehicle (see FIG. 1) consists of a main body, which like in a conventional vehicle (such as an aircraft, ship or ground vehicle), holds the payload, the energy storage and the powerplant. The body is designed as a lifting body, leading to lower Hoverfoil loadings, reducing structural loadings and reducing drag both in water and air operation. Three Hoverfoils placed under the flotation line of the main body are the main aero-hydrodynamic surfaces. Each of the Hoverfoils is located at the end of a "leg" (aka "wing") that connects it to the body.

Two of the Hoverfoils are placed at the rear section of the vehicle, one on each side, and are connected to the body through a wing each. The front Hoverfoil is placed at the end of a front boom that protrudes from the front of the body. The vehicle floats with its main body with the submerged lifting surfaces while on station, and raises above the water surface in forward flight. Two of the Hoverfoils are placed behind the center of gravity while a front Hoverfoil balances the vehicle longitudinally. The placement of a Hoverfoil in the front allows for all the lifting surfaces to lift upwards throughout the operational envelope, and helps push the center of gravity to the front. The front lifting surface presents a higher wing loading than the rear ones.

The control of the vehicle is achieved thanks to a combination of control surfaces and differential thrusters. The powerplant used on the alpha is battery-powered electric. Thrust is achieved using 5 electric ducted fans, powering each of the Hoverfoils, and providing forward thrust. The Hoverfoil-powering fans are placed in the main body and each have a separate intake at the top surface. The intakes at the top help create depression on the upper surface of the body slightly increasing lift and aspirating the boundary layer, which results in slightly reduced drag. Behind the fans, the air is directed to the lower surface of each of the Hoverfoils where it is injected at a slightly backwards angle. This airflow is a primary source of lift during takeoff and landing at very low speeds, and it confers the vehicle the capability of very short takeoff and landing, suitable for water operations. Two additional fans are placed horizontally in front of the center of gravity (CG) on top of the body and provide thrust like any conventional thruster on an aircraft. These two fans are the primary source of thrust and are used mainly in horizontal flight. Additionally, control surfaces add controllability to the vehicle. Each of the Hoverfoils is fitted with a servo motor which allows for independent pitch control. The differential actuation of the front and rear Hoverfoils provides pitch control while the differential actuation of the rear Hoverfoils provides roll. Yaw is achieved by differentially actuating the thrusters. The vehicle is fitted also with an elevator at the rear end of the body, which provides redundancy on pitch control and can actuate as a pitch trim. Two rudders (shown in outline) are placed at the trailing edges of the wings, providing additional yaw control.

FIGS. 2A and 2B depict an airfoil with an air duct (internal channel) placed at an angle of ~20 degrees with respect to the normal to the base plane and a smooth transition between the duct and the pressure surface (underside). The flow pattern for the geometry, in the "air on" condition is shown.

The phrases "operably connected to," "connected to," "coupled to," "operatively connected," or "operative connection" refer to any form of interaction between two or more entities, including mechanical, electrical, magnetic, electromagnetic, fluid, and thermal interaction. Likewise, "fluidically connected to" or "fluidically connecting" refers to any form of fluidic interaction between two or more entities. Two entities may interact with each other even though they are not in direct contact with each other. For example, two entities may interact with each other through an intermediate entity.

The term "proximal" is used herein to refer to "near" or "at" the object disclosed.

It will be apparent to those having skill in the art that many changes may be made to the details of the above-described embodiments without departing from the underlying principles of the invention.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A vehicle comprising: an airframe operatively connected to one or more blowers; an airfoil comprising an upper surface and a lower surface extending laterally along a leading edge to first and second arcuate wingtips defining a concave region bounded by the lower surface of the airfoil, wherein the airfoil comprises a channel extending from the upper surface to the lower surface of the airfoil, wherein the channel is in fluidic communication with at least one of the one or more blowers, and a wing member operably coupling the airfoil to the airframe and providing fluidic communication between the one or more blowers and the airfoil, wherein the wing member comprises a rudder element.

2. The vehicle of claim 1, further comprising first and second wing members each operably connected to separate first and second rear airfoils.

3. The vehicle of claim 2, wherein the separate first and second rear airfoils are adjacent the airframe without overlapping vertically with the airframe.

4. The vehicle of claim 1, wherein the airframe further comprises an elevator at a tail of the airframe.

5. The vehicle of claim 1, wherein the airfoil is pivotable in one dimension.

6. The vehicle of claim 1, wherein the airfoil further comprises a nozzle extending downward from the lower surface of the airfoil in fluidic communication with the channel of the airfoil.

7. The vehicle of claim 6, wherein the nozzle is extendable and retractable.

8. The vehicle of claim 1, further comprising multiple airfoils and wherein each airfoil is operably connected to a single blower.

9. The vehicle of claim 1, further comprising one or more propulsors separate from the one or more blowers.

10. The vehicle of claim 1, further comprising a single airfoil located longitudinally in front of the airframe and operably connected to the airframe and a single blower by a boom.

11. The vehicle of claim 1, wherein a lower portion of the channel is angled rearward, relative to the leading edge.

12. The vehicle of claim 11, wherein the lower portion of the channel is angled rearward 10 to 50 degrees, relative to vertical, 15 to 45 degrees, 20 to 30 degrees, or about 20 degrees.

13. An airfoil comprising an upper surface and a lower surface extending laterally along a leading edge to first and second arcuate wingtips defining a concave region bounded by the lower surface of the airfoil, wherein the airfoil is configured to be operatively connected to an airframe via the upper surface of each airfoil, wherein the airfoil comprises a channel extending from the upper surface to the lower surface of the airfoil, wherein the channel is configured to be in fluidic communication with at least one of one or more blowers, and wherein a lower portion of the channel is angled rearward, relative to the leading edge.

14. The airfoil of claim 13, wherein the lower portion of the channel is angled rearward 10 to 50 degrees, relative to vertical, 15 to 45 degrees, 20 to 30 degrees, or about 20 degrees.

15. The airfoil of claim 14, wherein the angled lower portion of the channel results in thrust as well as lift when fluid is blown through the channel.

16. A method of controlling a vehicle, the method comprising: providing a flying vehicle comprising: an airframe operatively connected to one or more blowers; at least two airfoils, wherein each airfoil comprises an upper surface and a lower surface extending laterally along a leading edge to first and second arcuate wingtips defining a concave region bounded by the lower surface of the airfoil, wherein the airfoil comprises a channel extending from the upper surface to the lower surface of the airfoil, wherein the channel is in fluidic communication with at least one of the one or more blowers; and first and second wing members each operably connected to separate first and second rear airfoil, wherein each wing member operably couples a respective airfoil to the airframe and providing fluidic communication between the one or more blowers and the airfoil, and wherein the first and second wing members each comprise a rudder element, respectively; controlling roll of the vehicle, at least partially, with a pitch of the first rear airfoil relative to a pitch of the second rear airfoil; and controlling yaw of the vehicle with the rudder element on each of the first and second wing members.

17. The method of claim 16, wherein the vehicle further comprises a single airfoil located longitudinally in front of the airframe and operably connected to the airframe by a boom, and wherein the method further comprises controlling at least partially a pitch of the vehicle by a pitch of the front airfoil.

18. The method of claim 16, wherein the vehicle further comprises at least two propulsors separate from the one or more blowers, and wherein the method further comprises controlling at least partially yaw of the vehicles by differential thrust in the at least two propulsors.

19. The method of claim 16, wherein the vehicle further comprises an elevator at a tail of the airframe, and wherein the method further comprises controlling at least partially a pitch of the vehicle by controlling a pitch of the elevator.

20. The method of claim 16, further comprising modulating a pressure underneath each airfoil via control of a separate blower operably connected to that airfoil.
